(19) United States
(12) Patent Application Publication
(10) Pub. No.: US 2007/0127896 A1
(43) Pub. Date: Jun. 7, 2007

(54) Method of heat drilling holes in ice and apparatus for carrying out the method

(76) Inventor: Erich Dunker, Otterndorf (DE)

Correspondence Address: LAW OFFICES OF KARL HORMANN, 86 SPARKS STREET, CAMBRIDGE, MA, 02138, US

(21) Appl. No.: 10/564,016

(22) PCT Filed: Jun. 27, 2004
(86) PCT No.: PCT/DE04/01382

§ 371 Date: Jan. 9, 2006

(30) Foreign Application Priority Data
Jul. 13, 2003 (DE) 103 32 571.9

(51) Int. Cl. H05B 3/02

(52) U.S. Cl. 392/301

(57) ABSTRACT

A method and apparatus for drilling a bore hole into ice by use of a water-heated hemispherical structure of circular cross-section and predetermined diameter for sinking a borehole into the ice following and closing a previdously formed pilot bore hole of lesser diameter, and, above it, in axial alignment therewith, an azimuthally circumferential gap for spraying a high pressure disk-shaped upwardly deflected jet of water against the circular wall of the bore hole to increase its diameter beyond the predetermined diameter and to form a smooth bore hole wall surface.

### BACKGROUND OF THE INVENTION

1. Field of the Invention

The present invention relates to a method of heat drilling of holes in ice as well as to an apparatus for practicing the method by means of a drill head heatable by hot water as well as to a supply unit and a hoisting and lowering crane unit.

2. The Prior Art

Drilling in ice is required for various purposes. A main field of application is polar research where the taking of ice samples as cores from the various ice regions of the polar caps, the in-situ-preparation of vertical ice profiles regarding different parameters of penetration or drilling through floating and shelf ice of the polar regions are of great importance for performing measurements and taking samples below the ice. Polar ice preserves data regarding climatic action of times past and as a climate archive it may extend back for several hundred thousand years. The age of the layers increases at increasing depths and because of pressure they become increasingly thin. For that reason, protective drilling techniques are required which affect the ice samples as little as possible or which ensure careful treatment of the measuring devices in the bore hole. Usually hollow drills are used for the drilling of ice cores from any depth for the purpose of climate research. A tube provided with saw teeth at its lower end is rotated under pressure into the ice, and the drill chips are removed by the outer annular gap with a sawed-out cylindrical piece of ice remaining as a core in the interior of the tube. In these mechanical techniques the core is maintained largely uneffected and free of drilling additives, so that the desired data remains preserved relatively undisturbed. For the preparation of ice profiles as regards physical and chemical parameters of the ice layers, such as thickness, contents of various trace materials, size of pores in the ice and population of cold-resistant micro organisms, the drilling operation is carried out by heat drilling processes. An electrically heated melting sensor melts through the ice while simultaneously performing desired measurements at the walls of the drill hole or of the thin melted layer of water at its tip. The cable supporting the sensor for deep bores is either stored in the sensor or, in the case of relatively simpler sensors for drilling at lesser depths, at the surface of the ice. The bore hole is not evacuated, and above the sensor it freezes up again. The sensor transmits its measuring values to the top by way of a signal wire and will be lost after termination of the measurements.

By contrast, drilling through floating ice mainly serves the purpose of examining the under surface of the ice, the water beneath it and the sea bottom. Drilling and measuring are carried out as separate operations. During the measuring period the bore hole is kept open for the retrieval of the measuring instrument after termination of the measuring operation. All known techniques may be applied for drilling. Mechanical drilling at high power is fast, heat drilling requires less power and involves simpler equipment, but it is correspondingly more time-consuming. For larger measuring instruments, sample takers or more extensive experiments the diameter of the bore hole has to be significantly larger than in melting sensor measuring bores. Especially for placing and retrieving instruments, the walls of the bore hole must be smooth in order to avoid jamming or bending out of line during hoisting and consequential loss of the instrument and measuring data. Electrically heated drill heads and/or drill heads operating with hot water may be used for heat drilling. In this connection, a distinction is made between melting drill heads using hot water for heating and rinsing bore heads using hot water for rinsing the ice. Usually the hot water is produced at limited heat capacity directly in the drill head. In either case, the melted water is removed upwardly by pumping. The heat from a drill heated exclusively by electricity attains no significant lateral penetration depth so that a drill of relatively large diameter and, thus, a correspondingly high supply of energy for the drill are required. Known drilling techniques using hot water yield bore diameters only in the range of the diameter of the rinsing drill head, so that in such cases, too, it is necessary to use large drill heads requiring significant supplies of energy.

Published specification DE 1 936 902 B (Method and Device for Sinking Bores into Ice) presents a heat drilling process and an appurtenant drill head provided with a crown-like bearing cutter and an electrical heat cartridge at the lower end of the drill head. The heat cartridge heast the drill head and a small reservoir of water in the vicinity thereof so that during sinking of the drill head which acts like a melting head are bore hole is melted. Above its lower end the drill head is provided with a cooling element for freezing the wall of the melted bore hole resulting in a bore hole of the diameter of the drill and with a hard but more or less wavy surface. To prevent the effect of heat from the drill on the completed bore hole, the heated and the cooled components of the drill are insulated from each other. The melted water is pumped away in an upward direction through a central pumping pipe. Owing to the narrow bore hole, bending out of line and jamming make hoisting and lowering of the drill, or of measuring instruments to be used later, over extended depths extremely problematic. This is particularly trough in respect of retrieving a measuring instrument from the water zone below the bore hole. The threading operation into the narrow bore hole is very difficult and not infrequently it leads to the loss of the measuring instrument and, therefore, the data. Moreover, the structure of the drill head is complex and, therefore, relatively expensive. A supply unit at the surface has to provide electrical current for heating and cooling. A crane with its impeding electrical cables for lowering and hoisting the drill is required as well.

The figure of SU 252,252 A1 (Thermodrill) discloses a drilling process in which the bode hole is formed by rinsing with hot water in a circulation. The rinsing water is perpetually sucked in centrally by a propeller, heated and pressed through a large axial annular opening in front of the drill head operating as a rinsing head in order to remove further ice by melting. The melt water is removed by suction. The drill is guided laterally. The diameters of the drill and of the bore hole coincide and result in a narrow bore hole so that the problems described supra may again be expected. Furthermore, it teaches nothing about the at least partial freezing over of the bore hole and the resulting difficulty as to hoisting and lowering of the drill or of measuring instruments.

The AMANDA neutrino telescope project in Antarctica used hot water drilling by a rinse drill head where the hot water is prepared and stored at the surface. The publication (it may be downloaded from the Internet under http;//wswww.physik.uni-mainz.de/lehramt/Schule/Pas/2001/Sterne+Weltraum %202001/sld052.htm, Status 9 Jun. 2003, states drilling parameters of an average bore diameter of 60 cm and a water temperature of 80° C. A photograph of the rinse head depicts a device with a downwardly directed water jet. However, the diameter profile of the bore shows a highly unsatisfactory fluctuating width of 45 cm to 75 cm. Bores of a bore fluctuating that much require that the minimum bore diameter be selected as the large one in order to avoid problems with hoisting and lowering and to take into consideration a disproportionate energy consumption.

### OBJECT OF THE INVENTION

Therefore, the object of the present invention is to improve the method of drilling holes into ice and to an apparatus for practicing the method such that a bore hole produced thereby is, over its entire length, of a constant circular and sufficiently large diameter for the passing of the drill itself as well as of a measuring instrument, with the wall being smooth and free of any profile formation. The bore diameter, especially of through bores, is to be sufficiently large to allow retrieval of measuring instruments from the water zone in a simple and safe manner. The apparatus for practicing the method is to be simple and economical as well as easily operable.

### SUMMARY OF THE INVENTION

In the accomplishment of this object the method in accordance with the invention provides for the following steps:
Forming a vertical pre-bore hole of small diameter by a melt drill head;
Depositing a melt-rinse-drill head of larger diameter on the pre-bore;
Heating water as a heat transfer medium on the surface of the ice;
Controlled pumping under pressure of the hot water to the melt-rinse-drill head;
Diverting the hot water in the area of the melt-wash drill head into a radial plane;
Rinsing the hot water in a sharp circulating disc-like jet radially against the wall of the bore hole with the hot water being mixed with the melt water and pressed into the direction of the ice surface;
Lowering the melt-rinse-drill head while forming a main bore hole; and
Seepage or pumping off the hot water mixed with the melt water pressed in the direction of the ice surface.

The method in accordance with the invention can be practiced particularly advantageously by an apparatus in which, based upon a device of the kind under consideration provided with a drill head heatable by hot water as well as with a supply and a hoisting and lowering crane unit, the drill head is structured as a combination melt-wash drill head provided at its upper end with an axial water input and at its lower end with a hemispherical melting section as well as, above the melting section but below the water intake, with a narrow azimuthally circumferential annular gap as a water outlet connected to the water intake, the entire melt-wash drill head being constructed of a highly heat-conductive material.

The thermal drilling method in accordance with the invention represents a combination melt and rinse process capable of forming, with relatively small drill heads, bore holes of large diameter into great depths. For this purpose hot water of high heat capacity is being applied which is prepared on the surface of the ice where energy stores may be used which can easily accommodate heating of large quantities of water and which also can supply hot water without any delay. There is no need for large heating devices in the drill which, like flow-through heaters, would have to be very power efficient to avoid time delays. The melting process is realized by pumping hot water into the melt-wash drill head and the heating thereof, whereas the rinsing process is realized by the controlled lateral exit of hot water from the melt-wash drill head. The combination of melt drilling and rinse drilling, the forward melt drilling provides for forward movement of the drill head in the bore hole and the pressurized rinse drilling provides for lateral widening of the bore hole to its large constant diameter with the water ejection taking place behind the forwardly disposed melting area. The lateral water ejection in particular is particularly responsible for the melting of large bore holes of constant diameter.

Internal tests have shown that for producing such large-format bore holes in the range of from 500 to 1,000 mm in floating ice or in the shelf ice of polar coastal regions, pre-bores measuring 50 to 100 mm in diameter are necessary as a straight guide for the main bore hole. The ice is completely penetrated by this bore hole which is also produced thermally. Since the ice is positioned in water up to a depth of several meters, at the moment of break through sea water will enter into the bore hole up to the height of the generally prevailing sea and become mixed with the melt water originating from the drilling process. During the ensuing main drilling, using a known rinse drill head and conventional technology with exclusively downwardly directed hot water jets, the desired bore hole diameter can be attained by melting in front of and around the rinse drill head at most only to several meters in front of the lower end of the bore hole. Several meters above the lower end of the bore hole the jet action of the water jets leads, in the manner of a water jet pump, to sucking in cold sea water of a temperature of −1.8 to −2.0° C. through the pre-bore hole. This results in cooling down the bore hole in the area in front of and behind the drill head to the point that a bore hole diameter only slightly larger than the diameter of the rinse drill head can be attained. This will lead to the known disadvantages. Hence, a measuring program cannot be performed satisfactorily by conventional rinse drill processes. However, with the method in accordance with the invention, the hot water entering the combined melt-wash drill head is first passed by the melting area for heating it and then it is radially deflected and is pressed out under high pressure through the azimuthally circumferential annular gap. The hot water jet impacts the wall of the bore hole at high velocity and can directly release the effect of its heat.

Moreover, because the lateral exit of the water the hemispherically rounded lower end of the melt-wash drill head practically engages the lower end of the melted large-volume bore hole and by its weight it substantially closes the central pre-bore hole. The melted water which because of the hot melting area of the melt-wash drill head is present at the end of the bore hole forms a thin film between the melt-wash drill head and the ice surface and uniformly distributes the heat energy. The melt water runs off above the water level into the pre-bore hole. Cold water is now no longer sucked in by the radially ejected disk-like hot water jet and through the pre-bore hole closed by the melt-wash drill head so that the desired bore diameter can be formed over then entire length of the bore hole. The flat water jet deflected upwardly along the wall of the bore hole provides for an unimpeded uniformly round surface of the bore hole free of any cavities and profile ridges and for a constant diameter of the bore hole. By use of the apparatus in accordance with the invention the goal of bore holes formed for the purpose of conveying and subsequently retrieving large-format testing devices below shelf ice is reached without the costs and without the logistic complexity of large bore hole projects. The melt-wash drill head in accordance with the invention consists only of static and mechanically stable structural components. Rotating and otherwise moved elements and live electrical connecting cables are avoided which results in an extremely robust and strong structure. The hose, instead of an electric cable, leading to the drilling site for the supply of hot water, because of its temperature, the good insulation notwithstanding, is not subject to the hazard of freeze-connecting. Also, its compressive stiffness prevents it from buckling and twisting. Therefore, disturbances during hoisting and lowering of the melt-wash drill head in the bore hole are unlikely to occur.

In advantageous embodiments of the invention, water is heated to temperatures of up to 90° C. and the hot water is pumped into the bore hole at pressure in the range of 10⁷ Pa. The is no technical problem in providing a well-insulated water storage on the surface of the ice. Solar energy in particular may be added for heating the water. Simple pumps which are not affected by the coldness may be used to generate the high hot water pressure. The pumps may be driven, for instance, by combustion engines by way of in situ aggregates. Furthermore, it may be advantageous that at a bore hole depth of up to 50, m a cavern is washed out by the rinse water into which the rinse water mixed with melt water may be pumped for seeping dissipation. Temperature and pressure of the hot water define the possible advance of the bore hole by melting the ice while maintaining such bore hole parameters as diameter and smoothness of the bore hole wall. The ice at depths up to 50 meters is pourous and pervious to water. In order to prevent flooding of the drilling site by pumped-out melt water, it may be pumped into a cavern. When rinsing the cavern and for the first 50 meters of the bore holes suction is not generally necessary as the melt water will dissipate by seepage. Only at greater depths the melt water mixed with the hot water has to be removed by pumping. Because of the high temperature the pumped off water is recycled in order to save considerable energy for preparing the hot water.

The returning measuring instruments sunk below the ice into the bore hole represent a special problem during their retrieval. Thus it is possible that the measuring instrument is pushed away laterally of the bore hole by various tidal currents. During its retrieval it can, therefore, be bent out of line at the undersurface of the ice or the cable may cut into the ice. One solution would be to take currents into consideration as a function of time such as the change of tides. However, a threading aid is also of advantage. For that reason, it would be possible in accordance with the invention to insert a cylindrical guide element on a cable as a retrieval aid in the main bore hole at its area of transition between the lower edge of the ice and the sea. The guide element may be a simple ring or pipe; but it may also be provided with a flared and crimped margin similar to a funnel without sharp edges. The cross-sectional narrowing of the cylindrical funnel element may be tolerated since the diameter of the bore hole may be dimensioned to be of adequate size.

The is no direct melting of ice in front of the rinse head by vertical hot water jets. The drilling advance is carried out exclusively by advancing the melt of the melting zone within the guide of the pre-drilled bore. The water jet deflected in the radial plane of the drill head rinses the large diameter of the bore hole and the wall but in this function it is depending upon the advance of the of the melt-wash drill head sinking as a function of the melting action. Therefore, the melt-wash drill head in accordance with the invention is constructed of a material of high heat conductivity so that the hot water in the interior heats up the lower end of the rinse head sufficiently for melting the ice at the end of the bore hole at a diameter equal to the drill head.

An advantageous embodiment of thermal drilling in accordance with the invention provides for an azimuthally circumferential gap of a width of about one millimeter in the melt-wash drill head for generating the high pressure necessary for the desired rinsing action of the disk-like water jet extending over the entire circle of 360°. The diameter of the bore hole and its rate of advance may be determined by the opening of the annular gap. In order to provide an improved thermal connection of the hemispherical melting section at the lower end of the melt-wash drill head with the end of the bore hole, the thermally highly conductive material of the melt-wash drill head is copper. This is an easily processed and cost-efficient material which is resistant against the effects of water. Also, the interior of melt-wash drill head in the area below the annular gap may be hollow and may be provided with a plurality of radial vanes connected to the annular gap by large surfaces which constitute heat bridge for a particularly good transmission of heat from the hot water to the melting zone for melting the ice in front of the melt-rinse head. Furthermore, the melt-wash drill head may be constructed of a plurality of hydraulically tightly connected radial layers. The layer structure is of advantage as regards the manufacture and possibly required cleaning of the melt-wash drill head. It also makes it possible separate replacement of the part of the annular gap which subject to excessive wear. Finally, it may be advantageous to form a unit out of the hose for feeding hot water to the axial water input and a cable for hoisting and lowering the melt-wash drill head. This avoids the need for a separate cable and by way of simplification the crane need wind and unwind one element only. Because of its reinforced structure made necessary by the requisite high compression strength, the hot water feed hose is suitable on its own for hoisting and lowering the weight of the melt-wash drill head.

### DESCRIPTION OF THE SEVERAL DRAWINGS

The novel features which are considered to be characteristif=c of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 is a cross-sectional view of the terminal section of the main bore hole including the melt-rinse head as detail of the apparatus in accordance with the invention;

FIG. 2 depicts two sectional views of the melt-wash drill head of FIG. 1 with laminar structure and layer structure; and

FIG. 3 is an overall view of a completed main bore hole including retrieval aid.

### DETAILED DESCRIPTION OF THE PREFERRED EMBODIMENT

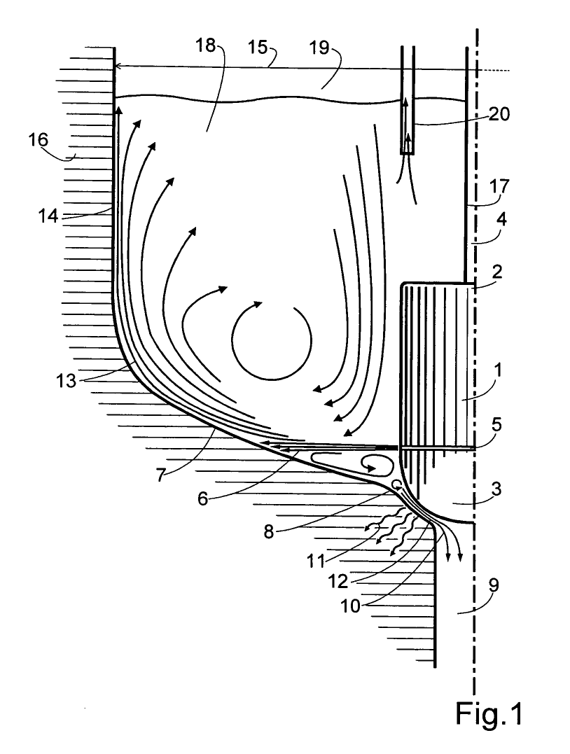

FIG. 1 is a detailed sectional view of a melt-wash drill head 1 of the apparatus in accordance with the invention for heat drilling holes into ice. At its upper end it is provided with an axially extending water input 2, and at its lower end it is provided with a hemispherically rounded melting section 3. Hot water 4 heated on the surface of the ice is pumped into the melt-wash drill head 1 and deflected into the radial plane of the melt-wash drill head 1. There it is ejected from a narrow azimuthally circumferential annular gap 5 as a sharp disk-like hot water jet 6 and engages the wall 7 of the bore hole under high pressure. Since no water escapes downwardly from the melt area 3, the melt-wash drill head 1 is seated by its melt section 3 of upon the lower end 8 of the bore hole. In this manner, a previously formed pre-bore hole 9 is closed for all intents and purposes. Owing to the hot water flowing through the entire melt-wash drill head 1 is sufficiently heated to introduce heat energy (indicate by arrows 11 in FIG. 1) into the lower end 8 of the bore hole, especially in the melting area 3 thereof, so as to affect melting in the area of the pre-bore hole 9 with the melt water 10 forming a stable and sealing water film 12 between the melting area 3 of the melt-wash drill head 1 and the lower end 8 of the bore hole. Within the ambit of its constant thermal and kinetic energy, a water jet 13 deflected upwardly at the wall 7 of the bore hole, under constant conditions of pressure and temperature washes out a main bore hole 19 of circular cross-section, smooth bore hole surface 14 and uniform diameter 15, free of caverns and profile grooves. Such a main bore hole 19 is suitable for receiving large apparatus and conveying large apparatus below the ice 16 and for safely retrieving them as well. The hot water 4 is fed to the melt-wash drill head 1 via a feed hose 17. After dispensing its energy for melting the main bore hole 19, the water mixes with the melt water 18 and is pumped upwardly through a cavern hose 20.

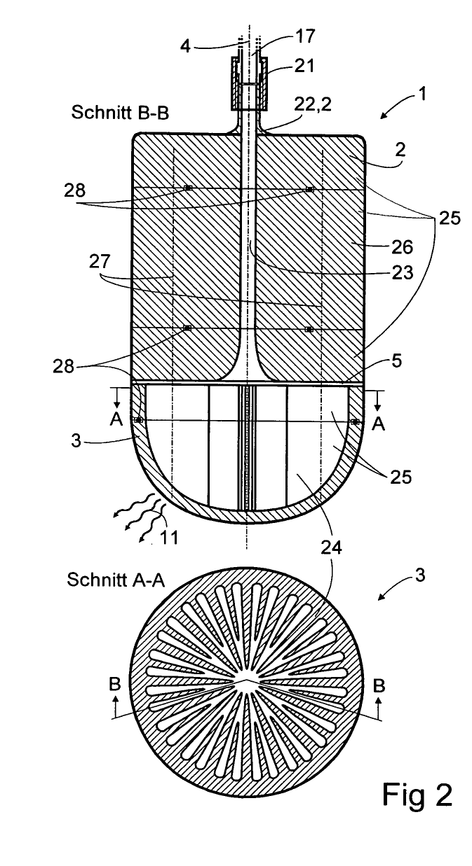

FIG. 2 in its upper portion depicts a view in longitudinal section of the upper section of the melt-wash drill head 1 of FIG. 1 and, in its lower portion, a cross-sectional view of the melt section 3. The feed hose 17 for hot water 4 is connected by a central hose screw connection 21 to an axial input stub 22 of the water input 2 at the upper end of the melt-wash drill head 1. The hot water 4 flows through a central channel 23 to the melt section 3 of the melt-wash drill head 1 where it flows through a structure of heat-conducting vanes 24 and is then ejected under high pressure to the exterior through the annular gap 5. The structure of vanes 24 distributes the hot water 4 in the melt section 3 of the melt-wash drill head 1 so that heat energy 11 can be uniformly disseminated to the ice 16 at the end of the bore hole 8. For a simply variable and serviceable structure the melt-wash drill head 1 shown is constructed of a plurality of radial layers 25 held together by a clamp 27 and hydraulically sealed by sealing elements 28. The weight of a central radial layer 26 may be used overall to control the weight of the melt-wash drill head 1 in accordance with the invention.

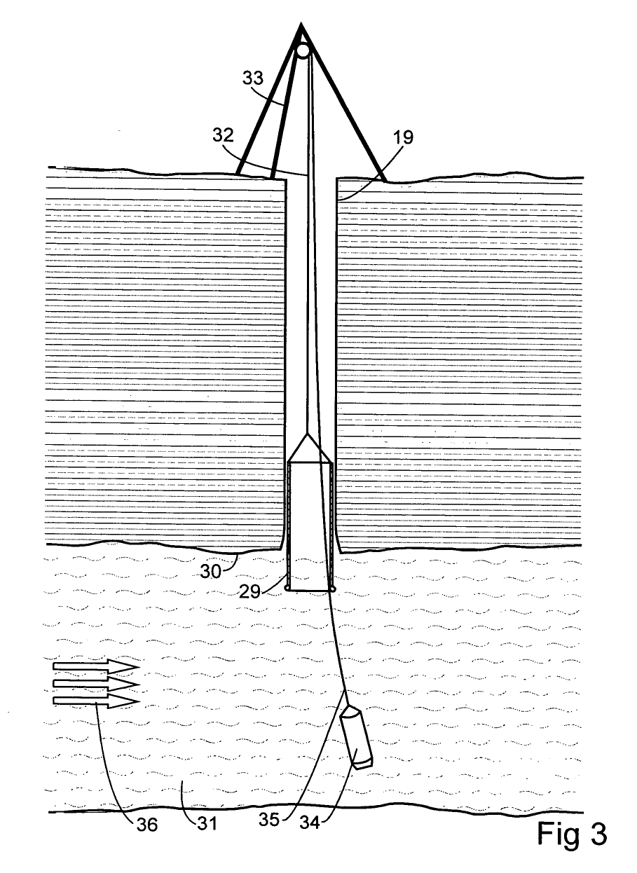

FIG. 3 illustrates on a reduced scale a completed main bore hole 19 provided with a cavern 37 and including a crane apparatus 33 positioned over the bore hole 19 on which a measuring device 34 including its supporting measuring line 35 is suspended in the free water of the sea 31. The measuring apparatus 34 is drifted off in the current 36 and no longer hangs vertically below the lower surface 30 of the ice. Depending upon the force of the drift, the measuring line 35 may cut into the ice at the lower edge of the main bore hole 19 and thus imperil the retrieval of the measuring apparatus 34. To prevent this hazard, there is provided, on a suspension cable 32 which can also be hoisted and lowered by the crane apparatus 33, a cylindrical guide element 29 as a retrieval aid 54 between the lower edge of the ice 30 and the sea 31, provided, for instance, with a crimped margin for aiding in the threading operation.

What is claimed is:

1. A method of heat drilling holes into ice, comprising the steps of:
forming a vertical pre-bore hole (9) of small diameter with a melt-wash drill head;
positioning a melt-wash drill head (1) of larger diameter on the pre-bore hole (9);
heating water as a heat carrier on the surface of the ice;
controlled pumping under pressure of the hot water (4) into the rinse-wash drill head;
deflecting the hot water (4) in the range of the melt-wash drill head (1) into a radial plane (5);
washing the hot water (4) as a sharp disk-like jet (6) circumferentially radially against the wall of the bore hole (7) whereby the hot water (4) is mixed with the melt water (10) and pressed into the direction of the surface of the ice;
lowering of the melt-wash drill head (1) for forming a main bore hole (19); and
dissipating by seepage or pumping the hot water (4) pressed in the direction of the surface of the ice and mixed with the melt water (10).

2. The method of claim 1, characterized by
the water being heated to temperatures of up to 90° C.

3. The method of one of claims 1, characterized by
the hot water (4) being pumped at pressures of up to the range of 10⁷ Pa.

4. The method of claim 1, characterized by
a cavern being washed out with the wash water at a depth of up to 50 meters and the wash water mixed with the melt water (10) being pumped into it for dissipation by seepage.

5. The method of claim 1, characterized by
a cylindrical guide element (29) being inserted by a cable (32) into the main bore hole (19) in the transition range between the lower ide edge (30) and the sea (31).

6. An apparatus for practicing a method of heat drilling holes into ice by a
drill head heatable by hot water as well as a supply and hoisting and lowering crane device, especially in accordance with one of claims 1 to 5, characterized by
the drill head being structured as a combination melt-wash drill head (1) provided at its upper end with an axial water input (2) and at its lower end with a hemispherical melt section (3) as well as above the melt section (3) but below the water input (2) with a narrow azimuthally circumferental annual gap (5) connected to the water input (2) as the water output, the entire melt-wash drill head (1) being formed of a material of good heat conductivity.

7. The apparatus of claim 6, characterized by
the azimuthally circumferential annular gap (5) being of a width in the range of a millimeter.

8. The apparatus of claim 6, characterized by
the material of good heat conductivity being copper.

9. The apparatus of claim 6, characterized by the melt-wash drill head (1) being hollow in the range below the annular gap (5) and a plurality of radial vanes (24) being connected with the annular gap (5) by large surfaces.

10. The apparatus of claim 6, characterized by the melt-wash drill head (1) being constructed of a plurality of hydraulically tightly clamped together radial layers (25).

11. The apparatus of claim 6, characterized by a hose (17) for feeding the hot water (4) to the axial water input (4) and a cable for hoisting and lowering the melt-wash drill head (1) form a unit.
